(19) United States
(12) Patent Application Publication
(10) Pub. No.: US 2022/0204770 A1
(43) Pub. Date: Jun. 30, 2022

(54) PRIMER FOR SILICONE RUBBER COMPOSITIONS AND ELASTOMERIC MATERIALS

(71) Applicant: DOW SILICONES CORPORATION, Midland, MI (US)

(72) Inventors: Roman VANECEK, Wiesbaden (DE); Patrick BEYER, Wiesbaden (DE)

(21) Appl. No.: 17/605,598

(22) PCT Filed: Apr. 28, 2020
(86) PCT No.: PCT/US2020/030179

§ 371 Date: Oct. 22, 2021

Related U.S. Application Data
(60) Provisional application No. 62/839,838, filed on Apr. 29, 2019.

(51) Int. Cl. C08L 83/06; C09D 183/06; B32B 25/20; B32B 25/04; B32B 7/12

(52) U.S. Cl. CPC C08L 83/06; C09D 183/06; B32B 25/20; B32B 25/042; B32B 2255/10; C08L 2205/035; C08L 2203/18; B32B 2255/26; B32B 7/12

(57) ABSTRACT

Provided is a primer composition and the preparation and use thereof. The primer composition comprises a silicone polyether, a reinforcing filler, one or more polydiorganosiloxane polymer(s), and a carrier. The primer composition is particularly designed for use with silicone elastomers, especially for addition (hydrosilylation) curing silicone elastomers. Also provided is a process for improving the adhesion of silicone elastomeric compositions to pre-cured silicone elastomer material substrates via the primer composition.

### CROSS-REFERENCE TO RELATED APPLICATIONS

This application is the U.S. National Stage of International Application No. PCT/US2020/030179 filed on 28 Apr. 2020, which claims priority to and all advantages of U.S. Provisional Application No. 62/839,838 filed on 29 Apr. 2019, the contents of which is incorporated herein by reference.

### TECHNICAL FIELD

This disclosure identifies a primer composition and the preparation and use thereof. The primer composition is particularly designed for use with silicone elastomers (often referred to as “silicone rubbers”) especially for addition (hydrosilylation) curing silicone elastomers, the preparation thereof, and to a process for improving the adhesion of silicone elastomeric compositions to pre-cured silicone elastomer material substrates.

### BACKGROUND

Silicone elastomers have properties which make them preferable to other elastomers in many applications, an example being their thermal stability over a wide temperature range. In some applications where silicone elastomer/silicone elastomer overmolding is desired e.g., subsea insulation, high-voltage electrical insulation, 3-D printing, lens and consumer applications, strong bonds need to be developed between pre-formed silicone elastomeric materials and uncured silicone elastomeric compositions as they cure. If an adequate bond to the silicone elastomer substrate cannot be achieved directly the bond strength can be improved by pretreatment of the substrate surface with a suitable primer.

For example, silicone elastomeric insulation material is used to insulate subsea oil and gas production equipment. In many subsea locations e.g., where subsea oil and gas wells are located at depths of 1500 m or greater, the pipelines and wellhead equipment are exposed to seawater which is just a few degrees above freezing (e.g., about 4 to 5° C.). In the absence of insulation hot produced hydrocarbon fluids within the production equipment are cooled by the surrounding seawater which, if the temperature of the fluids approaches the seawater temperature, can result in hydrates and paraffin waxes being formed within the pipe line consequentially causing a restriction of hydrocarbon flow or even blockages within the pipelines.

To perform successfully in this environment, a thermal insulation material must have a low thermal conductivity, exhibit acceptable mechanical properties such as flexibility and impact resistance, and be economical to install and preferably should be resistant to high temperature aqueous environments.

Liquid silicone rubber (LSR) based materials made using organopolysiloxane polymers having viscosities of up to about 500,000 mPa·s at 25° C. have been utilised for subsea insulation but whilst having advantages over the above because of the ability to withstand wide temperature variations without an appreciable effect on their physical properties and being virtually unaffected by ultraviolet radiation, even over long periods of time, ozone, oil, salt, water and the like,

Furthermore, because of the relatively low viscosity of the pre-cured LSR compositions, it is difficult to apply the compositions around subsea equipment, such as the pipes, wellheads and Christmas trees, LSR insulation material is applied onto items of subsea equipment for insulation purposes using a sequential molding (cast-in-place) process. In such a process a mold/form is placed in position for a first section of insulation around the item, liquid silicone rubber is subsequently pumped in and cured to a predetermined hardness and the mold/form is then removed. The process is then repeated for a second section and consequently for as many sections as required to complete the total insulation of the item of subsea equipment. However, such a sequential process results in multiple joint sections having neighboring LSR/LSR (silicone elastomeric/silicone elastomeric) interfaces.

It is generally anticipated that such interfaces will adhere together in both subsea and all the other applications referred to above because the LSRs utilised for such insulation applications are provided with an excess of silicon bonded hydrogen groups (Si—H groups) so that post cure a sufficient proportion of unreacted Si—H groups are available at the cured interface of a first section in order to interact with unsaturated groups in the interface of a subsequently curing second section resulting in the two sections to completely cure the interfaces to a desired crosslink density. The same scenario being repeated between a cured interface of the second section with an uncured third section and for each subsequent section cured in place sequentially until the subsea item has been fully insulated with the neighboring sections adhered to each other sufficiently strongly for cohesive failure evident along the entire matrix.

However, whilst the silicone rubber insulation provides excellent insulative properties it has been identified that the adhesion/bonding between adjacent interfaces of neighboring sections is often inadequate for purpose, particularly given the extreme temperatures and environmental conditions endured.

A wide variety of primers have previously been proposed for adhering liquid silicone rubbers to substrates. The efficiency of the primer is dependent both on the chemical nature and surface characteristics of the substrate, and composition which is to be adhered to the substrate e.g., the nature of the adjacent interfaces of neighboring section of insulation, the crosslinking system and the viscosity of the silicone rubber which is to be adhered. Whilst a wide variety of primers have been proposed a large proportion are combinations of two or more of organofunctional alkoxysilanes such as tetraalkoxysilanes, epoxytrialkoxysilane, vinyltrialkoxysilane and/or methacryloxypropyltrimethoxysilane or partial hydrolysis products of such organofunctional alkoxysilanes, SiH functional intermediates, metal alkoxides and/or metal chelates e.g., titanates often together with a suitable solvent. These may be provided as one part or multi-part compositions mixed together immediately prior to use.

Examples include:
(i) a titanium alkoxide and an alkyl polysilicate or partial hydrolysis product thereof;
(ii) tetraalkyl titanate, at least one alkyl orthosilicate and a hydrocarbon solvent;
(iii) a tetraalkyl titanate, an organyloxysilane, for example tetraethyl orthosilicate, and an organic solvent;
(iv) a silane which contains no amino or amido functionality such as methacryloyloxypropyltrimethoxysilane, a metal ester, preferably an inorganic acid, and an organic solvent; and
(v) a tetraalkoxysilane and/or partial hydrolysis product thereof; a metal salt, alkoxide, or chelate and/or a partial hydrolysis product thereof; a silicone resin; and a solvent.

WO/2018/234783 which describes a subsea insulation system utilised two distinct primers. In this system there was a dual layer of silicone elastomer insulation around substrates e.g., metal pipes. A first primer was used to adhere the silicone elastomer to the metal substrate while the second primer was utilised to adhere the overmolding of a second layer of silicone rubber onto a base layer of silicone rubber. The description advises that the primers may be the same but, in the examples, they were different and the primer for the silicone elastomer/silicone elastomer interface consisted of

a) A linear polydialkylsiloxane having from 3 to 15 silicon atoms, alternatively 3 to 10 silicon atoms.

b) RₙSi—(OR⁹)₄₋ₙ where n may be 0, 1 or 2 preferably n is 0 or 1 and R may be a non-hydrolysable silicon-bonded organic group such as hydrocarbyl groups and each R⁹ is the same or different and is an alkoxy group having from 1 to 6 carbon atoms.

c) A Titanate of the general formula Ti[OR²]₄ where each R² may be the same or different and represents a monovalent, primary, secondary or tertiary aliphatic hydrocarbon group which may be linear or branched containing from 1 to 10 carbon atoms; and

d) RₙSi—(OR³)₄₋ₙ

where n may be 0, 1 or 2 preferably n is 0 or 1 where R is as above and each R³ is the same or different and is an alkoxy group having from 1 to 6 carbon atoms or an alkoxyalkylene group in which the alkoxy group has from 1 to 6 carbon atoms and the alkylene chain has from 1 to 6 carbon atoms.

There is still a need in the industry for a primer that is easy to apply in an industrial environment, that provides for strong silicone elastomer to silicone elastomer layer adhesion.

### SUMMARY

In accordance with the present disclosure there is provided a primer composition comprising
A) a silicone polyether
B) a reinforcing filler
C) one or more polydiorganosiloxane polymer(s) having a viscosity of from 1000 to 500,000 mPa·s at 25° C. containing at least one alkenyl group or alkynyl group per molecule and
D) a carrier.

It will be appreciated that conventional primers typically contain ingredients which undergo chemical reactions to enhance the adhesive properties such as alkoxysilanes, which hydrolyze with moisture subsequent to application in a primer and the undergo condensation reaction in order to be enhance adhesion with such primers therefore also the primers also regularly contain condensation catalysts, usually titanium and/or zirconium based condensation catalysts to accelerate this hydrolysis/condensation reaction. It will be noted therefore that primer described herein is of a completely different formulation which substantially won't react when exposed to humidity.

### DETAILED DESCRIPTION

Component A of the primer described herein is a silicone polyether, i.e., a copolymer comprising a combination of siloxane and polyether (i.e., polyoxyalkylene) blocks.

Each silicone portion of the silicone polyether is a polydiorganosiloxane chain having multiple units of the formula (I):

RₐSiO_{(4-a)/2} (I)

in which each R is independently selected from an aliphatic hydrocarbyl, aromatic hydrocarbyl, or organyl group (that is any organic substituent group, regardless of functional type, having one free valence at a carbon atom). Saturated aliphatic hydrocarbyls are exemplified by, but not limited to alkyl groups such as methyl, ethyl, propyl, pentyl, octyl, undecyl, and octadecyl and cycloalkyl groups such as cyclohexyl. Unsaturated aliphatic hydrocarbyls are exemplified by, but not limited to, alkenyl groups such as vinyl, allyl, butenyl, pentenyl, cyclohexenyl and hexenyl; and by alkynyl groups. Aromatic hydrocarbon groups are exemplified by, but not limited to, phenyl, tolyl, xylyl, benzyl, styryl, and 2-phenylethyl. Organyl groups are exemplified by, but not limited to, halogenated alkyl groups such as chloromethyl and 3-chloropropyl; nitrogen containing groups such as amino groups, amido groups, imino groups, imido groups; oxygen containing groups such as polyoxyalkylene groups, carbonyl groups, alkoxy groups and hydroxyl groups. Further organyl groups may include sulfur containing groups, phosphorus containing groups and/or boron containing groups. In the case of the present polyether each R is generally independently selected from an aliphatic hydrocarbyl, aromatic hydrocarbyl. The subscript “a” may be 0, 1, 2 or 3, but is typically mainly 2 or 3.

The foregoing siloxy units in (I) above may be described in a shorthand (abbreviated) nomenclature, namely—“M,” “D,” “T,” and “Q”, when R is an organic group, typically methyl group (further teaching on silicone nomenclature may be found in Walter Noll, Chemistry and Technology of Silicones, dated 1962, Chapter I, pages 1-9). The M unit corresponds to a siloxy unit where a=3, that is R₃SiO_{1/2}; the D unit corresponds to a siloxy unit where a=2, namely R₂SiO_{2/2}; the T unit corresponds to a siloxy unit where a=1, namely R1SiO_{3/2}; the Q unit corresponds to a siloxy unit where a=0, namely SiO_{4/2}. Hence when a in (I) above is 2 the siloxy unit is a D unit and when a is 3 the siloxy unit is a T unit. Generally, in silicone polyethers the silicone blocks comprise chains of D units with branching via T units possible. Examples of typical R groups on the polydiorganosiloxane polymer (i) include mainly alkenyl, alkyl, and/or aryl groups, alternatively alkyl groups having 1 to 6 carbons, alternatively methyl groups. The groups may be in pendent position (on a D or T siloxy unit) or may be terminal (on an M siloxy unit).

The polyether portion of such copolymers comprises recurring oxyalkylene units, illustrated by the average formula (—CₙH₂ₙ—O—)_{y} wherein n is an integer from 2 to 4 inclusive and y is an integer ≥4 i.e., of at least four. Moreover, the oxyalkylene units are not necessarily identical throughout the polyoxyalkylene but can differ from unit to unit. A polyoxyalkylene, for example, can comprise oxyethylene units (—C₂H₄—O—), oxypropylene units (—C₃H₆—O—) or oxybutylene units (—C₄H₈—O—), or mixtures thereof. Preferably the polyoxyalkylene polymeric backbone consists essentially of oxyethylene units or oxypropylene units. Other polyoxyalkylenes may include for example: units of the structure:

—[—R^{e}—O—(—R^{f}—O—)ₕ—Pn—CR^{g}₂—Pn—O—(—R^{f}—O—)_{q1}—R^{e}]—

in which Pn is a 1,4-phenylene group, each R^{e} is the same or different and is a divalent hydrocarbon group having 2 to 8 carbon atoms, each R^{f} is the same or different and is an ethylene group or propylene group, each R^{g} is the same or different and is a hydrogen atom or methyl group and each of the subscripts h and q1 is a positive integer in the range from 3 to 30.

One preferred type of polyether chain within the silicone polyether is a polyoxyalkylene polymer chain comprising recurring oxyalkylene units of the formula (—CₙH₂ₙ—O—) wherein n is an integer from 2 to 4 inclusive.

Generally, the end of each polyoxyalkylene block Z¹ is linked to a siloxane block by a divalent organic group. This linkage is determined by the reaction employed to prepare the block silicone polyether copolymer. The divalent organic groups at the ends of Z¹ may be independently selected from divalent hydrocarbons containing 2 to 30 carbons and divalent organofunctional hydrocarbons containing 2 to 30 carbons. Representative, non-limiting examples of such divalent hydrocarbon groups include; ethylene, propylene, butylene, pentylene, hexylene, heptylene, octylene, and the like. Representative, non-limiting examples of such divalent organofunctional hydrocarbons groups include acrylate and methacrylate. In one alternative the divalent hydrocarbon groups include; ethylene, propylene, butylene, pentylene, hexylene, heptylene or octylene, alternatively ethylene, propylene, butylene.

The silicone polyether may be of any type, for example the silicone polyether may be (AB)n type silicone poly-ether wherein blocks of a siloxane unit and polyoxyalkylene organic units repeat to form the copolymer but in the present case have M terminal groups and as such may be depicted as

M(DZ¹)_{z}M

Wherein M and D are defined above and each Z¹ is a polyoxyalkylene polymer chain block and z is an integer ≥2 and M is an Me₂OHSiO_{1/2} terminal group. Alternatively, the silicone polyether may be an ABA type silicone polyether of the type MDZ¹DM wherein M is Me₂OHSiO_{1/2} or a hydroxy terminated Z¹DZ¹ silicone polyether such as, for the sake of example

H—(O(CH₂)₂)_{d}—O—(CH₂)₃—Si(CH₃)₂—O[Si(CH₃)₂—O]ₑ—Si(CH₃)₂—(CH₂)₃—O—((CH₂)₂O)_{d}—H

Where d and e are integers.

Alternatively the copolymer may take the form of a “rake” copolymer where a predominately linear polyorganosiloxane provides the “backbone” of the copolymer architecture with pendant organic blocks forming the rake which may depicted as

MD¹ₓD²_{y}M

Wherein M is as defined above and D¹ represents a unit of the formula (R³)₂SiO_{2/2}, and D² represents a unit of the formula (R³)(Z²)SiO_{2/2}, wherein Z² represents is a monovalent polyether block and R³ is as described above.

In one alternative when the copolymers are ABA or (AB)_{z} type copolymers as described above, d is 1, 2 or 3 and for rake copolymers d is zero, 1, 2 or 3, alternatively zero or 1, alternatively zero.

The viscosity of the ABA or (AB)n type block silicone polyether copolymers is preferably between from 1000 mPa·s to 200,000 mPa·s at 25° C. using a Brookfield® rotational viscometer using Spindle (LV-4) and adapting the speed according to the polymer viscosity and all viscosity measurements were taken at 25° C. unless otherwise indicated.

When the copolymer is a rake copolymer, it is preferred that the organic component Z² is a polyether-containing substituent comprising recurring oxyalkylene units of the formula (—CₙH₂ₙ—O—) wherein n is an integer from 2 to 4 inclusive. The polyether-containing substituent may be linked to a silicon atom in the polymer backbone chain via a divalent organic group as described above for Z¹ and has a terminal —OH or alkoxy group, wherein the alkoxy group has from 1 to 6 carbon atoms, alternatively —OH or a methoxy or ethoxy group, alternatively an —OH group. Typically, the polyether side chains in such rake copolymers will contain from 2 to 150 alkylene oxide units per side chain.

The primer composition herein is described by way of solids content weight % (wt. %), i.e., the weight % of ingredients of the primer excluding carrier (D) i.e., (A), (B), (C) and any additives when present) and/or total content weight % (wt. %) for compositions wherein the amount of carrier (D) present is included. In each instance the composition when all ingredients are added together makes 100 wt. %.

Silicone polyether (A) is present in an amount of from 0.05 wt. % to 10 wt. % of the solids content of the composition alternatively 0.05 wt. % to 7.5 wt. % of the solids content of the composition alternatively 0.1 wt. % to 5.0% wt. of the solids content of the composition. Hence, for example, the silicone polyether may be present in the total composition in an amount of from 0.05 wt. % to 4 wt. % of the total composition, alternatively 0.05 wt. % to 2.5 wt. % of the total composition, alternatively 0.1 wt. % to 2.5% wt. of the total composition.

Component (B) of the composition is a reinforcing filler such as finely divided fumed silica and/or a finely divided precipitated silica and/or suitable silicone resins.

Finely divided forms of silica are preferred reinforcing fillers (B). Precipitated silica fumed silica and/or colloidal silicas are particularly preferred because of their relatively high surface area, which is typically at least 50 m²/g (BET method in accordance with ISO 9277: 2010). Fillers having surface areas of from 50 to 450 m²/g (BET method in accordance with ISO 9277: 2010), alternatively of from 50 to 300 m²/g (BET method in accordance with ISO 9277: 2010), are typically used. All these types of silica are commercially available.

When reinforcing filler (B) is naturally hydrophilic (e.g., untreated silica fillers), it is typically treated with a treating agent to render it hydrophobic. These surface modified reinforcing fillers (B) do not clump and can be homogeneously incorporated into polydiorganosiloxane polymer (C), described below, as the surface treatment makes the fillers easily wetted by polydiorganosiloxane polymer (C).

Typically reinforcing filler (B) may be surface treated with any low molecular weight organosilicon compounds disclosed in the art applicable to prevent creping of organosiloxane compositions during processing. For example, organosilanes, polydiorganosiloxanes, or organosilazanes e.g., hexaalkyl disilazane, short chain siloxane diols or fatty acids or fatty acid esters such as stearates to render the filler(s) hydrophobic and therefore easier to handle and obtain a homogeneous mixture with the other ingredients. Specific examples include, but are not restricted to, silanol terminated trifluoropropylmethyl siloxane, silanol terminated vinyl methyl (ViMe) siloxane, tetramethyldi(trifluoropropyl)disilazane, tetramethyldivinyl disilazane, silanol terminated MePh siloxane, liquid hydroxyl-terminated polydiorganosiloxane containing an average from 2 to 20 repeating units of diorganosiloxane in each molecule, hexaorganodisiloxane, hexaorganodisilazane. A small amount of water can be added together with the silica treating agent(s) as processing aid.

The surface treatment may be undertaken prior to introduction in the composition or in situ (i.e., in the presence of at least a portion of the other ingredients of the composition herein by blending these ingredients together at room temperature or above until the filler is completely treated. Typically, untreated reinforcing filler (B) is treated in situ with a treating agent in the presence of polydiorganosiloxane polymer (C) which results in the preparation of a silicone rubber base material which can subsequently be mixed with other ingredients.

Reinforcing filler is present in an amount of from 5.0 to 40 wt. % of the solids content of the composition, alternatively of from 7.5 to 35 wt. % of the solids content of the composition, alternatively of from 10.0 to 35 wt. % based on the weight % of the solids content of the composition. Hence, the amount of reinforcing filler (B) e.g., finely divided silica and/or silicone resins in the primer composition herein may therefore be for example, from 2.0 to 20 wt. % of the total composition, alternatively of from 2.5 to 15 wt. % of the total composition. In some instances, the amount of reinforcing filler may be of from 5.0 to 15 wt. % based on the weight of the total composition.

Component (C) is one or more polydiorganosiloxane polymer(s) having a viscosity of from 1000 to 500,000mPa·s at 25° C. containing at least alkenyl and/or at least one alkynyl group per molecule, alternatively at least two alkenyl and/or alkynyl groups per molecule, alternatively at least two alkenyl groups per molecule. Like the siloxane chains in silicone polyether (A), polydiorganosiloxane polymer (C) has multiple units of the formula (I):

RₐSiO_{(4-a)/2} (I)

in which each R is independently selected from an aliphatic hydrocarbyl, aromatic hydrocarbyl, or organyl group (that is any organic substituent group, regardless of functional type, having one free valence at a carbon atom). Saturated aliphatic hydrocarbyls are exemplified by, but not limited to alkyl groups such as methyl, ethyl, propyl, pentyl, octyl, undecyl, and octadecyl and cycloalkyl groups such as cyclohexyl. Unsaturated aliphatic hydrocarbyls are exemplified by, but not limited to, alkenyl groups such as vinyl, allyl, butenyl, pentenyl, cyclohexenyl and hexenyl; and by alkynyl groups. Aromatic hydrocarbon groups are exemplified by, but not limited to, phenyl, tolyl, xylyl, benzyl, styryl, and 2-phenylethyl. Organyl groups are exemplified by, but not limited to, halogenated alkyl groups such as chloromethyl and 3-chloropropyl; nitrogen containing groups such as amino groups, amido groups, imino groups, imido groups; oxygen containing groups such as polyoxyalkylene groups, carbonyl groups, alkoxy groups and hydroxyl groups. Further organyl groups may include sulfur containing groups, phosphorus containing groups and/or boron containing groups. The subscript “a” may be 0, 1, 2 or 3, but is typically mainly 2 or 3.

Examples of typical groups on the polydiorganosiloxane polymer (C) include mainly alkenyl, alkyl, and/or aryl groups. The groups may be in pendent position (on a D or T siloxy unit) or may be terminal (on an M siloxy unit). Hence, suitable alkenyl groups in polydiorganosiloxane polymer (C) typically contain from 2 to 10 carbon atoms, e.g., vinyl, isopropenyl, allyl, and 5-hexenyl.

The silicon-bonded organic groups attached to polydiorganosiloxane polymer (C) other than alkenyl groups are typically selected from monovalent saturated hydrocarbon groups, which typically contain from 1 to 10 carbon atoms, and monovalent aromatic hydrocarbon groups, which typically contain from 6 to 12 carbon atoms, which are unsubstituted or substituted with groups that do not interfere with curing of this inventive composition, such as halogen atoms. Preferred species of the silicon-bonded organic groups are, for example, alkyl groups such as methyl, ethyl, and propyl; and aryl groups such as phenyl.

The molecular structure of polydiorganosiloxane polymer (C) is typically linear, however, there can be some branching due to the presence of T units (as previously described) within the molecule.

The viscosity of polydiorganosiloxane polymer (C) should be at least 1000mPa·s at 25° C. The upper limit for the viscosity of polydiorganosiloxane polymer (C) is limited to a viscosity of up to 500,000mPa·s at 25° C.

Generally, the or each polydiorganosiloxane containing at least two silicon-bonded alkenyl groups per molecule of ingredient (C) has a viscosity of from 1000 mPa·s to 150,000mPa·s at 25° C., alternatively from 1000mPa·s to 125,000mPa·s, alternatively from 1000mPa·s to 50,000mPa·s at 25° C. In each case above the viscosity is measured in accordance with the cup/spindle method of ASTM D 1084 Method B, using the most appropriate spindle from the Brookfield® RV or LV range for the viscosity range.

The polydiorganosiloxane polymer (C) may be selected from polydimethylsiloxanes, alkylmethylpolysiloxanes, alkylarylpolysiloxanes or copolymers thereof containing e.g., alkenyl and/or alkynyl groups and may have any suitable terminal groups, for example, they may be trialkyl terminated, alkenyldialkyl terminated or may be terminated with any other suitable terminal group combination providing each polymer contains at least two alkenyl groups per molecule. Alternatively, polydiorganosiloxane may be partially fluorinated, e.g., it may comprise trifluoroalkyl, e.g., trifluoropropyl groups and or perfluoroalkyl groups. Hence the Polydiorganosiloxane polymer (C) may be, for the sake of example, dimethylvinyl terminated polydimethylsiloxane, dimethylvinylsiloxy-terminated dimethylmethylphenylsiloxane, trialkyl terminated dimethylmethylvinyl polysiloxane or dialkylvinyl terminated dimethylmethylvinyl polysiloxane copolymers.

For example, a polydiorganosiloxane polymer (C) containing alkenyl groups at the two terminals may be represented by the general formula (II):

R′R″R′″SiO—(R″R′″SiO)ₘ—SiOR′″R″R′ (II)

In formula (II), each R′ may be an alkenyl group or an alkynyl group, which typically contains from 2 to 10 carbon atoms. Alkenyl groups include but are not limited to vinyl, propenyl, butenyl, pentenyl, hexenyl an alkenylated cyclohexyl group, heptenyl, octenyl, nonenyl, decenyl or similar linear and branched alkenyl groups and alkenylated aromatic ringed structures. Alkynyl groups may be selected from but are not limited to ethynyl, propynyl, butynyl, pentynyl, hexynyl an alkynylated cyclohexyl group, heptynyl, octynyl, nonynyl, decynyl or similar linear and branched alkenyl groups and alkenylated aromatic ringed structures.

R″ does not contain ethylenic unsaturation, Each R″ may be the same or different and is individually selected from monovalent saturated hydrocarbon group, which typically contain from 1 to 10 carbon atoms, and monovalent aromatic hydrocarbon group, which typically contain from 6 to 12 carbon atoms. R″ may be unsubstituted or substituted with one or more groups that do not interfere with curing of this inventive composition, such as halogen atoms. R′″ is R′ or R″.

The one or more polydiorganosiloxane polymer(s) (C) having a viscosity of from 1000 to 500,000mPa·s at 25° C. containing at least one alkenyl group or alkynyl group per molecule is present in an amount of from 40 to 90 wt. %% of the solids content of the composition; alternatively, from 45 to 85 wt. % of the solids content of the composition, alternatively from 50 to 85 wt. % of the solids content of the composition. Hence, organopolysiloxane polymer (C), is typically a dimethylvinyl terminated polydimethylsiloxane present in an amount of from 15 to 45 wt. % of the total composition; alternatively, from 15 to 40 wt. % of the total composition, alternatively from 15 to 35 wt. % of the total composition.

Component D of the composition is a suitable carrier i.e., a diluent suitable for reducing the viscosity of a composition containing e.g., components A, B and C to allow application to a substrate in a low viscosity liquid form by a suitable method such as spraying, rolling, brushing, application with a knife coater or the like or the substrate may in certain circumstances be coated by immersion in a bath of primer. Any suitable carrier may be utilised for this purpose. The carrier may optionally be volatile so that component D is able to at least partially evaporate after application. The carrier may include short chain siloxanes containing from 3 to 20 Silicon atoms in the siloxane backbone, alternatively from 3 to 10 silicone atoms in the siloxane backbone; alternatively, from 3 to 6 silicon atoms in the siloxane backbone and may be linear branched or cyclic, although linear short chain siloxanes are preferred. Any such siloxanes are preferably non-VOC compounds which evaporate at room temperature or thereabouts. The carrier may alternatively be a suitable organic carrier which may, if deemed appropriate be volatile to enable partial evaporation after application. Examples include toluene, xylene, and similar aromatic hydrocarbon system solvents; n-hexane, ligroin, kerosene, mineral spirits, and similar aliphatic hydrocarbon system solvents; cyclohexane, decahydronaphthalene, and similar cycloaliphatic hydrocarbon system solvents; methanol, ethanol, n-propyl alcohol, isopropyl alcohol, n-butyl alcohol, isobutyl alcohol, tert-butyl alcohol, amyl alcohol, hexyl alcohol, and similar alcohol system solvents; acetone, methyl ethyl ketone, methyl isobutyl ketone, cyclohexanone, and similar ketone system solvents; diethylether, dibutylether, tetrahydrofuran, -1,4-dioxane, and similar ether system solvents; diethyl carbonate, dipropyl carbonate, ethylene carbonate, propylene carbonate, and other carbonate system solvents; ethyl acetate, n-propyl acetate, isobutyl acetate, and other acetic esters; and malonic esters, succinic esters, glutaric esters, adipate esters, phthalate esters, and other ester system solvents.

The solids content of the primer may be diluted by the carrier in any suitable amount for the application in which it is to be used. For example, there may be 20 to 150 parts by weight, alternatively from 70 to 150 parts by weight of carrier (D) per 100 parts by weight of the solids content of the composition (i.e., (A)+(B)+(C)+additive(s)). Hence, for example the carrier may be present in the primer in a range of from 50 wt. % to 80 wt. % of the total composition, alternatively from 55 wt. % to 75 wt. % of the total composition.

As mentioned above, optionally, the primer may comprise one or more additional ingredients, for example one or more organohydrogenpolysiloxanes or a hydrosilylation catalyst (but not both together as this would promote cure to take place). Examples of organohydrogenpolysiloxanes which might be included in the primer if desired include, for example,
(a) trimethylsiloxy-terminated methylhydrogenpolysiloxane,
(b)) trimethylsiloxy-terminated polydimethylsiloxane-methylhydrogensiloxane,
(c) dimethylhydrogensiloxy-terminated dimethylsiloxane-methylhydrogensiloxane copolymers,
(d) dimethylsiloxane-methylhydrogensiloxane cyclic copolymers,
(e) copolymers and/or silicon resins consisting of (CH₃)₂HSiO_{1/2} units, (CH₃)₃SiO_{1/2} units and SiO_{4/2} units,
(f) copolymers and/or silicone resins consisting of (CH₃)₂HSiO_{1/2} units and SiO_{4/2} units,
(g) copolymers and/or silicone resins consisting of (CH₃)₂HSiO_{1/2} units, SiO_{4/2} units and (C₆H₅)₃SiO_{1/2} units, and alternatives in which methyl is replaced by phenyl groups or other alkyl groups.

Alternatively, the organohydrogenpolysiloxane may be a filler, e.g., silica treated with one of the above. Si—H compounds are discussed in more detail below.

The hydrosilylation catalysts which may be used as an additive in the primer are any suitable hydrosilylation catalyst that can be used to cure hydrosilylation curable silicone compositions as discussed below. In particular one of the platinum metals (platinum, ruthenium, osmium, rhodium, iridium and palladium), or a compound of one or more of such metals. Platinum and platinum compounds are preferred due to the high activity level of these catalysts in hydrosilylation reactions. Any of the hydrosilylation catalysts indicated below might be introduced into the primer if required.

Hence the primer may comprise

A) a silicone polyether in an amount of from 0.05 wt. % to 10 wt. % of the solids content of the composition alternatively 0.05 wt. % to 7.5 wt. % of the solids content of the composition alternatively 0.1 wt. % to 5.0% wt. of the solids content of the composition;

B) a reinforcing filler in an amount of from 5.0 to 40 wt. %, alternatively of from 7.5 to 35 wt. %, alternatively of from 10.0 to 35 wt. % based on the weight % of the solids content of the composition;

C) one or more polydiorganosiloxane polymer(s) having a viscosity of from 1000 to 500,000mPa·s at 25° C. containing at least one alkenyl group or alkynyl group per molecule in an amount of from 40 to 90 wt. % of the solids content of the composition; alternatively from 45 to 85 wt. % of the solids content of the composition, alternatively from 50 to 85 wt. % of the solids content of the composition; wherein the solids content of the composition is the composition content excluding carrier (D), i.e., (A), (B), (C) and any additives when present; and Carrier (D) may be present in an amount of from 20 to 150 parts by weight, alternatively from 70 to 150 parts by weight of a carrier (D) per 100 parts by weight of the solids content of the composition. The solids content of the composition being any combination of the composition content excluding carrier (D), i.e., (A), (B), (C) and any additives when present but the total solids content of the composition by wt. % is 100 wt. %

Hence, for the sake of example, when including when the carrier is included in the total composition, the total composition may be:—

A) a silicone polyether in an amount of from 0.05 wt. % to 4 wt. % of the composition alternatively 0.05 wt. % to 2.5 wt. % of the composition alternatively 0.1 wt. % to 2.5% wt. of the composition;

B) a reinforcing filler in an amount of from 2.0 to 20 wt. %, alternatively of from 2.5 to 15 wt. %, alternatively of from 5.0 to 15 wt. % based on the weight of the composition

C) one or more polydiorganosiloxane polymer(s) having a viscosity of from 1000 to 500,000mPa·s at 25° C. containing at least one alkenyl group or alkynyl group per molecule in an amount of from 15 to 45 wt. % of the composition; alternatively, from 15 to 40 wt. % of the composition, alternatively from 15 to 35 wt. % of the composition; and

D) a carrier in a range of from 50 wt. % to 80 wt. % of the composition alternatively from 55 wt. % to 75 wt. %.

The total composition may be any combination of the above alone or with additional additives with the total composition adding up to 100% including component (D) content.

As previously discussed, historically primers utilised to enhance the adhesion of silicone elastomers to substrates typically rely on “reactive chemistry processes” e.g., the application of alkoxysilanes, which need to hydrolyze with moisture and then undergo a condensation reaction to be active with such a process being accelerate if required by use of a condensation catalyst e.g., titanium or zirconium based compounds. The composition of our primer is considered non-reactive, as on its own no reaction occurs prior to application of the curable silicone elastomer composition as no catalyst or curing agent is present to induce crosslinking.

Whilst most prior art primers for silicone materials require a period of time, say at least 20 or 30 minutes, to air-dry in order for volatile carriers to evaporate and/or to vulcanize/condense; given the components of the primer described herein are typically unreactive with each other, a curable silicone rubber composition can be applied on to the primer herein almost immediately after primer application, although a short period of some drying time may be allowed if the carrier is volatile.

The preparation of the primer composition as hereinbefore described may be by any suitable method, for example by uniform mixing of components (A), (B), (C) and any optional components present in the composition in carrier (D) in a suitable mixing unit. The initial mixture may be either the complete composition or may be in the form of a concentrate or masterbatch which may be diluted by addition of further carrier (D).

Hence, there is also provided a method for improving the adhesion of silicone rubber to a substrate by applying the primer composition according to the invention to the substrate. Advantageously, it is not necessary to subject the cured substrate to any pre-treatment or cleaning step prior to applying the primer, i.e., methods, such as corona treatment, plasma treatment, flame treatment, UV irradiation are unnecessary. The primer composition may be applied using any suitable known method, for example, depending on the viscosity of the primer composition the primer may be applied by spraying, rolling, brushing, application with a knife coater or the like or the substrate may in certain circumstances be coated by immersion in a bath of primer. Typically, immediately upon application a uniform primer film covering the substrate is provided. However, if required, the primer may be allowed to air-dry for a period of time at room temperature on the substrate surface prior to application of silicone elastomer composition e.g., for 2 to 10 minutes. Alternatively, the substrate coated with primer may be heated to accelerate the drying process if deemed necessary. The primer coating on the substrate, is typically in the region of 0.01 to 3 mm thick, alternatively 0.01 to 2 mm thick. After formation of a uniform primer film covering the substrate, a curable silicone elastomer composition is applied in a form required and is subsequently cured to obtain an overmolded composite with an adhesive bond between the original silicone rubber substrate and the cured composition applied thereto. It would appear that hydrosilylation curable elastomeric compositions may be overmolded on to a hydrosilylation cured substrate which has had the present primer pre-applied and the subsequently cured overmolded layer reliably remains adhered to the pre-cured substrate.

The silicone elastomeric substrate may have been prepared by curing a peroxide-crosslinking or hydrosilylation (addition)-crosslinking-silicone elastomer composition or a similarly by curing a fluorosilicone elastomer composition. Such compositions will generally also contain a filler and/or suitable cure package as described herein. The substrate may be cured from a composition comprising any suitable organosiloxane homopolymer, copolymer or mixtures of these polymers wherein the repeating units are one or more of, for example, dimethylsiloxane, methylvinylsiloxane, methylphenylsiloxane, phenylvinylsiloxane, 3,3,3-trifluoropropylmethylsiloxane, 3,3,3-trifluoropropylvinylsiloxane and/or 3,3,3-trifluoropropylphenylsiloxane.

The substrate composition as described herein may be cured with a hydrosilylation cure package as described below or with a peroxide catalyst or mixtures of different types of peroxide catalysts.

The peroxide catalyst may be any of the well-known commercial peroxides used to cure silicone and/or fluorosilicone elastomer compositions. The amount of organic peroxide used is determined by the nature of the curing process, the organic peroxide used, and the composition used. Typically, the amount of peroxide catalyst utilised in a composition as described herein is from 0.2 to 3 wt. %, alternatively 0.2 to 2 wt. % in each case based on the weight of the composition.

Suitable organic peroxides include for the sake of example, substituted or unsubstituted dialkyl-, alkylaroyl-, diaroyl-peroxides, e.g., benzoyl peroxide and 2,4-dichlorobenzoyl peroxide, ditertiarybutyl peroxide, dicumyl peroxide, t-butyl cumyl peroxide, bis(t-butylperoxyisopropyl) benzene, bis(t-butylperoxy)-2,5-dimethyl hexyne, 2,4-dimethyl-2,5-di(t-butylperoxy) hexane, di-t-butyl peroxide, and 2,5-bis(tert-butyl peroxy)-2,5-dimethylhexane. When the substrate composition is peroxide cured said composition may additionally comprise an organohydrogenpolysiloxane having at least 2, alternatively at least 3 Si—H groups per molecule as described below.

The hydrosilylation curable silicone elastomer composition used for application onto the primer treated silicone elastomer substrate may comprise:
(i) One or more polydiorganosiloxane polymers such as component C in the primer composition described above;
(ii) A reinforcing filler, typically a silica reinforcing filler such as component B in the primer composition together with a hydrosilylation cure package.
   The hydrosilylation cure package contains an organohydrogenpolysiloxane having at least 2, alternatively at least 3 Si—H groups per molecule (iii), a hydrosilylation catalyst (iv) and optionally a cure inhibitor (v).

The hydrosilylation curable silicone elastomer composition used for application onto the primer treated silicone elastomer substrate is cured using a hydrosilylation catalyst package in the form of

(iii) an organohydrogenpolysiloxane having at least 2, alternatively at least 3 Si—H groups per molecule;
(iv) a hydrosilylation catalyst; and optionally
(v) a cure inhibitor.
(iii) Organohydrogenpolysiloxane

Organohydrogenpolysiloxane (iii) of the hydrosilylation curable silicone elastomer composition used for application onto the primer treated silicone elastomer substrate functions as a cross-linker for curing polymer (i) by addition/hydrosilylation reaction of the silicon-bonded hydrogen atoms in component (iii) with the alkenyl groups in polymer (i) catalysed by component (iv) described below.

Organohydrogenpolysiloxane (iii) normally contains 3 or more silicon-bonded hydrogen atoms so that the hydrogen atoms can react with the unsaturated alkenyl or alkynyl groups of polymer (i) to form a network structure therewith and thereby cure the composition. Some or all of organohydrogenpolysiloxane (iii) may alternatively have 2 silicon bonded hydrogen atoms per molecule when polymer (i) has >2 alkenyl or alkynyl groups per molecule.

The molecular configuration of organohydrogenpolysiloxane (iii) is not specifically restricted, and it can be a straight chain, a straight chain with some branching, cyclic or silicone resin based. While the molecular weight of this component is not specifically restricted, the viscosity is typically from 0.001 to 50 Pa·s at 25° C. relying on the cup/spindle method of ASTM D 1084 Method B, using the most appropriate spindle from the Brookfield® RV or LV range for the viscosity range, in order to obtain a good miscibility with polymer (i).

Organohydrogenpolysiloxane (iii) of the hydrosilylation curable silicone elastomer composition used for application onto the primer treated silicone elastomer substrate is typically added in an amount such that the molar ratio of the total number of the silicon-bonded hydrogen atoms in organohydrogenpolysiloxane (iii) to the total number of alkenyl and/or alkynyl groups in polymer (i) is from 0.5:1 to 20:1. When this ratio is less than 0.5:1, a well-cured composition will not be obtained. When the ratio exceeds 20:1, there is a tendency for the hardness of the cured composition to increase when heated.

Examples of organohydrogenpolysiloxane (iii) include but are not limited to:

(a) trimethylsiloxy-terminated methylhydrogenpolysiloxane,
(b) trimethylsiloxy-terminated polydimethylsiloxane-methylhydrogensiloxane,
(c) dimethylhydrogensiloxy-terminated dimethylsiloxane-methylhydrogensiloxane copolymers,
(d) dimethylsiloxane-methylhydrogensiloxane cyclic copolymers,
(e) copolymers and/or silicon resins consisting of (CH₃)₂HSiO_{1/2} units, (CH₃)₃SiO_{1/2} units and SiO_{4/2} units,
(f) copolymers and/or silicone resins consisting of (CH₃)₂HSiO_{1/2} units and SiO_{4/2} units,
(g) copolymers and/or silicone resins consisting of (CH₃)₂HSiO_{1/2} units, SiO_{4/2} units and (C₆H₅)₃SiO_{1/2} units, and alternatives in which methyl is replaced by phenyl groups or other alkyl groups.
Alternatively, component (iii) may be a filler, e.g., silica treated with one of the above.

The silicon-bonded hydrogen (Si—H) content of organohydrogenpolysiloxane (iii) of the hydrosilylation curable silicone elastomer composition used for application onto the primer treated silicone elastomer substrate is determined using quantitative infra-red analysis in accordance with ASTM E168. In the present instance the silicon-bonded hydrogen to alkenyl (vinyl) and/or alkynyl ratio is important when relying on a hydrosilylation cure process. Generally, this is determined by calculating the total weight % of alkenyl groups in the composition, e.g., vinyl [V] and the total weight % of silicon bonded hydrogen [H] in the composition and given the molecular weight of hydrogen is 1 and of vinyl is 27 the molar ratio of silicon bonded hydrogen to vinyl is 27[H]/[V]. (iv) Hydrosilylation catalyst

When present hydrosilylation catalyst (iv) of the hydrosilylation curable silicone elastomer composition used for application onto the primer treated silicone elastomer substrate is preferably one of the platinum metals (platinum, ruthenium, osmium, rhodium, iridium and palladium), or a compound of one or more of such metals. Platinum and platinum compounds are preferred due to the high activity level of these catalysts in hydrosilylation reactions.

Examples of preferred hydrosilylation catalysts (iv) include but are not limited to platinum black, platinum on various solid supports, chloroplatinic acids, alcohol solutions of chloroplatinic acid, and complexes of chloroplatinic acid with ethylenically unsaturated compounds such as olefins and organosiloxanes containing ethylenically unsaturated silicon-bonded hydrocarbon groups. The catalyst (iv) can be platinum metal, platinum metal deposited on a carrier, such as silica gel or powdered charcoal, or a compound or complex of a platinum group metal.

Examples of suitable platinum-based catalysts include

(i) complexes of chloroplatinic acid with organosiloxanes containing ethylenically unsaturated hydrocarbon groups are described in U.S. Pat. No. 3,419,593;
(ii) chloroplatinic acid, either in hexahydrate form or anhydrous form;
(iii) a platinum-containing catalyst which is obtained by a method comprising reacting chloroplatinic acid with an aliphatically unsaturated organosilicon compound, such as divinyltetramethyldisiloxane;
(iv) alkene-platinum-silyl complexes as described in U.S. Pat. No. 6,605,734 such as (COD)Pt(SiMeCl₂)₂ where “COD” is 1,5-cyclooctadiene; and/or
(v) Karstedt's catalyst, a platinum divinyl tetramethyl disiloxane complex typically containing about 1 wt. % of platinum in a solvent, such as toluene may be used. These are described in U.S. Pat. Nos. 3,715,334 and 3,814,730.

The hydrosilylation catalyst (iv) of the hydrosilylation curable silicone elastomer composition used for application onto the primer treated silicone elastomer substrate is present in the total composition in a catalytic amount, i.e., an amount or quantity sufficient to catalyse the addition/hydrosilylation reaction and cure the composition to an elastomeric material under the desired conditions. Varying levels of the hydrosilylation catalyst (iv) can be used to tailor reaction rate and cure kinetics. The catalytic amount of the hydrosilylation catalyst (iv) is generally between 0.01 ppm, and 10,000 parts by weight of platinum-group metal, per million parts (ppm), based on the weight of the composition polymer (i) and filler (ii); alternatively, between 0.01 and 5000 ppm; alternatively, between 0.01 and 3,000 ppm, and alternatively between 0.01 and 1,000 ppm. In specific embodiments, the catalytic amount of the catalyst may range from 0.01 to 1,000 ppm, alternatively 0.01 to 750 ppm, alternatively 0.01 to 500 ppm and alternatively 0.01 to 100 ppm of metal based on the weight of the composition. The ranges may relate solely to the metal content within the catalyst or to the catalyst altogether (including its ligands) as specified, but typically these ranges relate solely to the metal content within the catalyst. The catalyst may be added as a single species or as a mixture of two or more different species. Typically, dependent on the form/concentration in which the catalyst package is provided the amount of catalyst present will be within the range of from 0.001 to 3.0 wt. % of the composition.

When the hydrosilylation curable silicone elastomer composition used for application onto the primer treated silicone elastomer substrate as hereinbefore described is being cured via an addition/hydrosilylation reaction component (v) an inhibitor may be utilised to inhibit the cure of the composition. These inhibitors (v) are utilised to prevent premature cure in storage and/or to obtain a longer working time or pot life of a hydrosilylation cured composition by retarding or suppressing the activity of the catalyst. Inhibitors (v) of hydrosilylation catalysts (iv), e.g., platinum metal-based catalysts are well known in the art and may include hydrazines, triazoles, phosphines, mercaptans, organic nitrogen compounds, acetylenic alcohols, silylated acetylenic alcohols, maleates, fumarates, ethylenically or aromatically unsaturated amides, ethylenically unsaturated isocyanates, olefinic siloxanes, unsaturated hydrocarbon monoesters and diesters, conjugated ene-ynes, hydroperoxides, nitriles, and diaziridines.

One class of known inhibitors (v) of hydrosilylation catalysts, e.g., platinum catalysts (iv) includes the acetylenic compounds disclosed in U.S. Pat. No. 3,445,420. Acetylenic alcohols such as 2-methyl-3-butyn-2-ol constitute a preferred class of inhibitors that will suppress the activity of a platinum-containing catalyst at 25° C. Compositions containing these inhibitors typically require heating at temperature of 70° C. or above to cure at a practical rate.

Examples of acetylenic alcohols and their derivatives include 1-ethynyl-1-cyclohexanol (ETCH), 2-methyl-3-butyn-2-ol, 3-butyn-1-ol, 3-butyn-2-ol, propargyl alcohol, 3,5-dimethyl-1-hexyn-3-ol, 1-ethynylcyclopentanol, 1-phenyl-2-propynol, 3-methyl-1-penten-4-yn-3-ol, and mixtures thereof.

When present, inhibitor (v) concentrations as low as 1 mole of inhibitor per mole of the metal of catalyst (iv) will in some instances impart satisfactory storage stability and cure rate. In other instances, inhibitor concentrations of up to 500 moles of inhibitor per mole of the metal of catalyst (iv) are required. The optimum concentration for a given inhibitor (v) in a given hydrosilylation curable silicone elastomer composition used for application onto the primer treated silicone elastomer substrate is readily determined by routine experimentation. Dependent on the concentration and form in which the inhibitor selected is provided/available commercially, when present in the composition, the inhibitor is typically present in an amount of from 0.0125 to 10 wt. % of the composition. Mixtures of the above may also be used.

Typically the hydrosilylation curable silicone elastomer composition used for application onto the primer treated silicone elastomer substrate is stored in two parts, often referred to as Part A and Part B with a view to separating organohydrogenpolysiloxane (iii) and catalyst (iv) prior to cure to avoid premature cure as will be discussed further below. Such 2-part compositions are composed to enable easy mixing immediately prior to use and are typically in a weight ratio of Part A:Part B of from 15:1 to 1:1.

### Additional Optional Components

Additional optional components may be present in the silicone elastomer composition depending on the intended use thereof. Examples of such optional components include electrical and thermally conductive fillers, non-conductive fillers, pot life extenders, flame retardants, lubricants, non-reinforcing fillers, pigments coloring agents, chain extenders, mold release agents, UV light stabilizers, bactericides, wetting agents, heat stabilizers, compression set improvement additives, and mixtures thereof.

The silicone rubber composition may be dependent on viscosity and application etc., be applied onto the primer-treated substrate by way of by injection moulding, encapsulation moulding, press moulding, dispenser moulding, extrusion moulding, transfer moulding, press vulcanization, centrifugal casting, calendering, bead application, 3-D printing or blow moulding.

Curing of the silicone rubber composition may be carried out as required by the type of cure package utilized. Whilst it is usually preferred to use raised temperatures for curing hydrosilylation cure systems e.g., from about 80° C. to 150° C., some applications for which the primer herein is suitable e.g., for subsea silicone rubber compositions, much lower temperatures may be utilised for the cure process, e.g., between room temperature and 80° C., alternatively between room temperature, i.e., about 23-25° C. to about 50° C.

The present primer is particularly suited for applications where silicone elastomer/silicone elastomer overmolding is desired, e.g., subsea insulation, high-voltage electrical insulation, 3-D printing, lenses, automotive applications and consumer applications, i.e., situations where strong bonds need to be developed between pre-formed silicone elastomeric materials and uncured hydrosilylation curable silicone elastomeric compositions as they cure. Whilst the overmolding may involve like silicone elastomers, i.e., those having the same or a very similar uncured composition, one particularly important application for the primers herein is to aid adhesion of silicone elastomeric materials having different properties for example different Shore A hardnesses, different colours, different optical transparencies, or any other difference in physical characteristics which may be advantageous for combination.

Hence, the primers as hereinbefore described may be suitable in the adherence of composite parts of articles such as in automotive applications housings with a silicone seal or gasket, plugs and connectors, components of various sensors, membranes, diaphragms, climate venting components, and the like. Composite parts may also include devices such as masks, goggles, tubing and valves catheters, ostomy appliances, respiratory appliances, feeding appliances, contact lenses, hearing aids, orthotics, prosthesis, and the like. Other composite parts which might need two layers of silicone having different physical properties (when cured) can include shower heads, bakery ware, spatulas, home appliances, shoes, footwear, sports and leisure articles, diving masks, face masks, pacifiers and other baby articles, feeding accessories, seals and surfaces of white good and other kitchen articles, and the like. Electronic applications may include silicone elastomer composites in mobile phone cover seal, mobile phone accessories, precision electronic equipment, electrical switches and switch covers, watches and wristbands, wearable electronic devices, and the like.

In the case of subsea insulation, silicone elastomeric materials are especially suited because the application requires any insulation material which is used must be able to withstand these extreme temperatures without detriment to its thermal or mechanical properties because of the extreme temperatures of the hydrocarbon fluids exiting wells, which in some cases may reach 150° C. or higher. The insulation needs to be resistant to the corrosive nature of seawater e.g., in the area immediately below the surface of the sea, up to a depth of about 50 m because it can be subjected to the effects of weather and turbulence under the surface due to prevailing weather conditions. In some instances, therefore the silicone elastomer composition used may comprise a syntactic medium such as microspheres, alternatively glass microspheres, particularly borosilicate glass microspheres.

Typically in subsea applications the silicone elastomeric composition to be adhered to the substrate will have the same or a very similar composition to that of the substrate prior to curing because it is used in sequential molding (cast-in-place) of insulating materials. Because of the relatively low viscosity of the hydrosilylation curable silicone elastomer compositions utilised in subsea insulation material, it is applied onto items of subsea equipment for insulation purposes using a sequential molding (cast-in-place) process. In such a process a mold/form is placed in position for a first section of insulation around the item, liquid silicone rubber is subsequently pumped in and cured to a predetermined hardness and the mold/form is then removed. The process is then repeated for a second section and consequently for as many sections as required to complete the total insulation of the item of subsea equipment. However, such a sequential process results in multiple joint sections having neighboring silicone elastomer/silicone elastomer interfaces. and whilst the silicone elastomer insulation provides excellent insulative properties it has been identified that the adhesion/bonding between adjacent interfaces of neighboring sections is often inadequate for purpose, particularly given the extreme temperatures and environmental conditions endured. Use of the primers as hereinbefore described have been found to enhance the adhesion at the interface between a pre-cured silicone elastomeric material and a curing silicone elastomeric material which has been cast in place adjacent thereto.

The primers as hereinbefore described may be utilised in the thermal insulation of subsea equipment such as, for the sake of example, piping including riser pipes, wellheads, Xmas trees, spool pieces, manifolds, risers, pipework, e.g., a pipeline, jumpers, pipeline end terminations (PLETs), pipe line end manifolds (PLEMs), coupling covers, doghouses (i.e., rooms, which are typically steel-sided, adjacent to an oilrig floor, usually having an access door close to the driller's controls. They are generally at the same elevation as the rig floor but may be cantilevered out from the main substructure supporting the rig. and/or pipe field joints using a cast in place process, whereby the primers described above are applied to surface of pre-cured silicone elastomeric material prior to a further section of silicone elastomer material (LSR) being introduced and cured with a view to ensuring the adhesion between multiple joint sections in the subsea insulation.

The following examples, illustrating the compositions and components of the compositions, elastomers, and methods, are intended to illustrate and not to limit the invention.

### EXAMPLES

In the following examples the ingredients used are in the following examples and Tables are listed below:

DOWSIL™ 3-6060 Prime Coat Primer—a commercial primer for silicones from Dow Silicones Corp (Michigan, USA);
Silicone Polyether—is a Dimethyl(propyl(poly (EO))hydroxy)siloxy-terminated Dimethyl Siloxane, of the structure

H—(O(CH₂)₂)_{d}—O—(CH₂)₃—Si(CH₃)₂—O[Si(CH₃)₂—O]ₑ—Si(CH₃)₂—(CH₂)₃—O—((CH₂)₂O)_{d}—H

which has a viscosity of 320 mPa·s at 25° C.;
Treated Fumed Silica is a fumed silica which has been treated with hexamethyldisilazane (HMDZ);
Vinyl Polymer is a Dimethylvinyl terminated polydimethylsiloxane having a viscosity of 2000mPa·s at 25° C.; and
Si—H Polymer is a trimethyl terminated Dimethyl-methylhydrogen-siloxane having a viscosity of 5mPa·s at 25° C. and 0.76 wt. % Si—H.

Excepting C.1, the compositions indicated in Table 1 are all comparative primer compositions not in accordance with the disclosure herein. C. 1 is a reference comparative example which uses no primer of any sort.

TABLE 1

| Components | C.1 | C.2 | C.3 | C.4 | C.5 | C.6 | C.7 | C.8 |
|---|---|---|---|---|---|---|---|---|
| DOWSIL ™ | | 100 | | | | | | |
| 3-6060 Prime | | | | | | | | |
| Coat Primer (wt. %) | | | | | | | | |
| Silicone Polyether | | | | | 0.14 | | 34 | 100 |
| (wt. %) | | | | | | | | |
| Treated Fumed | | | 6.0 | | | 11.9 | | |
| silica (wt. %) | | | | | | | | |
| Vinyl Polymer | | | 27.4 | 33.2 | 32.8 | 22.1 | | |
| (wt. %) | | | | | | | | |
| Octamethyltri- | | | 66 | 66 | 66 | 66 | 66 | |
| siloxane (wt. %) | | | | | | | | |
| Si—H Polymer | | | 0.65 | 0.8 | 1.03 | | | |
| (wt. %) | | | | | | | | |

The compositions of three example in accordance with the disclosure herein are depicted in Table 2 below.

TABLE 2

| Components | Ex.1 | Ex. 2 | Ex. 3 |
|---|---|---|---|
| Silicone polyether (wt. %) | 0.14 | 0.16 | 0.6 |
| Treated Fumed silica (wt. %) | 6.0 | 6.1 | 11.7 |
| Vinyl Polymer (wt. %) | 27.3 | 27.7 | 21.7 |
| Octamethyltrisiloxane (wt. %) | 66 | 66 | 66 |
| Si-H Polymer (wt. %) | 0.6 | | |

In order to test the comparative primers they were used in combination with a commercial subsea insulation material DOWSIL™ XTI-1003 RTV Silicone Rubber Insulation which is a room temperature vulcanizing 2 part hydrosilylation cured composition designed particularly but not exclusively for subsea insulation applications.

100 parts of DOWSIL™ XTI-1003 Base were homogeneously mixed with 10 Parts of DOWSIL™ XTI-1003 Curing Agent and de-gassed in a vacuum desiccator. Using a cast-in place process, the resulting mixture was then cast into an open top mold (300×300 mm) to achieve a 5 mm thick layer. The material was left for 24 h at room temperature and in the laboratory to cure. After 24 h the experimental primer was applied by brushing onto the cured surface. Good primer coverage on the surface was visually controlled. The experimental primer used was dried for a period of 10 minutes after which the first cast coated with primer was overmolded with freshly mixed DOWSIL™ XTI-1003 RTV Silicone Rubber Insulation material of the same 5 mm thickness. The overmolded combination was then left for a further period of 24 h to enable the second cast of the DOWSIL™ XTI-1003 RTV Silicone Rubber Insulation material to cure at room temperature in the same laboratory conditions.

A 1800 peel test method was used to determine the peel force between the two layer overmolded sample adhered together with the assistance of the primer utilised for the respective example. After the second cast material was fully cured 30 mm width strips were cut out for testing. Tests were performed on a Universalprifmaschine H10TMC 900 Watt machine from producer Hegewald & Peschke using following parameters:

test speed 100 mm/min,

### Load Cell 100 kN

Test length minimum 50 mm.

The results of the test for the comparative primers tested are depicted in Table 3 below and those for the examples in accordance with the present disclosure are depicted in Table 4 below.

TABLE 3

| Test results | C.1 | C.2 | C.3 | C.4 | C.5 | C.6 | C 7 | C.8 |
|---|---|---|---|---|---|---|---|---|
| Peel Force 180° [N] | 11 | 15.6 | 5.7 | 5.3 | 3.7 | 15.1 | 13.5 | 0 |

TABLE 4

| Test Results | Ex.1 | Ex. 2 | Ex. 3 |
|---|---|---|---|
| Peel Force 180° [N] | 53.3 | 82.5 | 57.5 |

Several conclusions can be made by comparing the comparative examples and examples above. It can be seen that the peel force results of the examples are significantly better than when used in combination with any of the comparative primers of Table 1. More specifically, comparing comparative 3 with Example 1 the silicone polyether is required in the composition for adhesion promoted by the primer, without the polyether the adhesion results were poor (comp.3). Similarly, it was found that by comparing comparative 5 with example 1 again that the silica is necessary for the primer to cause good adhesion. Furthermore, comparative 4 shows that the absence of both the polyether and silica results in poor adhesion, based on the peel tests. It had been anticipated that the adhesion would be enhanced by the introduction of the Si—H polymer but surprisingly when comparing examples 1 and 2 it was found that better results in the peel test performance were achieved in the absence of the Si—H polymer from the primer composition (although in its presence results were still much better than all the comparatives in Table 1). Example 3 indicated that increasing the levels of silicone polyether and silica did not improve results in the examples. Finally, comparatives 7 and 8 show that a combination of carrier and polyether gave poor peel test results and as such didn't function well as a primer and use of the silicone polyether alone in comparative 8 didn't work at all.

1. A primer composition, the composition comprising:
(A) a silicone polyether;
(B) a reinforcing filler;
(C) one or more polydiorganosiloxane polymer(s) having a viscosity of from 1000 to 500,000 mPa·s at 25° C. and containing at least one alkenyl group or alkynyl group per molecule; and
(D) a carrier.

2. The primer composition of claim 1, wherein component (A) comprises an ABA-type silicone polyether or an AB-type silicone polyether.

3. The primer composition of claim 1, wherein component (A) is an ABA-type silicone polyether of the general formula:
H—(O(CH₂)₂)_{d}—O—(CH₂)₃—Si(CH₃)₂—O[Si(CH₃)₂O]ₑ—Si(CH₃)₂—(CH₂)₃—O—((CH₂)₂O)_{d}—H
where each of d and e are integers.

4. The primer composition of claim 1, wherein component (B) comprises a filler selected from the group consisting of finely divided fumed silica, finely divided precipitated silica, a silicone resin, and combinations thereof.

5. The primer composition of claim 1, wherein component (C) is a dimethylvinyl-terminated polydimethylsiloxane.

6. The primer composition of claim 1, wherein component (D) is a short chain siloxane containing from 3 to 20 silicon atoms.

7. The primer composition of claim 1, comprising:
(A) the silicone polyether in an amount of from 0.05 to 10 wt. % of the solids content of the composition;
(B) the reinforcing filler in an amount of from 5.0 to 40 wt. % of the solids content of the composition;
(C) the polydiorganosiloxane polymer(s) in an amount of from 40 to 90 wt. % of the solids content of the composition;
wherein the solids content of the composition is the composition content excluding component (D); and
(D) the carrier in an amount of from 20 to 150 parts by weight, optionally of from 70 to 150 parts by weight, per 100 parts by weight of the solids content of the composition.

8. The primer composition of claim 1, comprising:
(A) the silicone polyether in an amount of from 0.05 to 4 wt. % of the total composition;
(B) the reinforcing filler in an amount of from 2.0 to 20 wt. % of the total composition:
(C) the polydiorganosiloxane polymer(s) in an amount of from 15 to 45 wt. % of the total composition; and
(D) the carrier in an amount of from 50 to 80 wt. % of the total composition.

9. A process for the preparation of the primer composition in accordance with claim 1, the process comprising uniformly dissolving or mixing components (A), (B), and (C) in component (D).

10. The process in accordance with claim 9, wherein the primer composition is diluted with further carrier after being dissolved or mixed together.

11. A method for improving the adhesion of silicone elastomer to a pre-cured silicone elastomeric substrate, the method comprising;
applying the primer composition in accordance with claim 1 to a silicone elastomer substrate;
optionally, air-drying or baking the primer composition to form a uniform primer film covering the substrate;
applying a hydrosilylation curable silicone rubber composition to the substrate covered with the primer to obtain a composite; and
curing the composite in order to obtain a silicone elastomer adhesively bonded to a silicone elastomer substrate.

12. The method for improving the adhesion of silicone elastomer to a pre-cured silicone elastomeric substrate in accordance with claim 11, wherein the substrate is prepared from a peroxide cured silicone elastomer composition and/or a hydrosilylation curable cured silicone elastomer composition.

13. The method in accordance with claim 11, wherein the hydrosilylation curable silicone rubber composition is applied onto the primer treated substrate by way of by injection moulding, a cast in place process, encapsulation moulding, press moulding, dispenser moulding, extrusion moulding, transfer moulding, press vulcanization, centrifugal casting, calendering, bead application, 3-D printing, or blow moulding.

14. The method in accordance with claim 11, wherein the hydrosilylation curable silicone rubber composition is applied onto the primer treated substrate via a cast in place process for the application of subsea insulation.

15. A silicone elastomer composite of multiple silicone elastomer articles adhered or overmolded together via the primer composition in accordance with claim 1.

16. The silicone elastomer composite in accordance with claim 15, wherein the composite is used in applications for subsea insulation, high-voltage electrical insulation, 3-D printing, lenses, automotive applications, and/or consumer applications.

17. The silicone rubber composite in accordance with claim 15, wherein the composite is a subsea insulation composite.

18. The silicone rubber composite in accordance with claim 17, wherein the subsea insulation composite is used to insulate one or more of a piping wellhead, an xmas tree, a spool piece, a manifold, a riser, a pipeline, a jumper, PLETs, PLEMs, a coupling cover, a doghouse, and/or pipe field joints.

19. The silicone rubber composite in accordance with claim 15, suitable in or for adherence of housings with a silicone seal or gasket; plugs and connectors, components of various sensors, membranes, diaphragms, climate venting components, masks, goggles, tubing and valves catheters, ostomy appliances, respiratory appliances, feeding appliances, contact lenses, hearing aids, orthotics, prosthesis, shower heads, bakery ware, spatulas, home appliances, shoes, footwear, sports and leisure articles, diving masks, face masks, pacifiers, seals and surfaces of white goods, mobile phone cover seal, mobile phone accessories, precision electronic equipment, electrical switches and switch covers, watches and wristbands and/or wearable electronic devices.

20. (canceled)
